(19) United States
(12) Patent Application Publication
(10) Pub. No.: US 2025/0124452 A1
(43) Pub. Date: Apr. 17, 2025

(54) METHOD AND SYSTEM FOR FRAUD DETECTION VIA LANGUAGE PROCESSING AND APPLICATIONS THEREOF

(71) Applicant: Verizon Patent and Licensing Inc., Basking Ridge, NJ (US)

(72) Inventors: Durgesh Kumar, Bangalore (IN); Saurabh Tahiliani, Noida (IN)

(73) Assignee: Verizon Patent and Licensing Inc., Basking Ridge, NJ (US)

(21) Appl. No.: 18/488,557

(22) Filed: Oct. 17, 2023

(51) Int. Cl. G06Q 20/40

(52) U.S. Cl. CPC G06Q 20/4016; G06Q 20/407

(57) ABSTRACT

The present teaching relates to customer service with AI-based automated auditing on agent fraud. Real-time features of a communication between an agent and a customer are obtained. To detect agent fraud, a batch feature vector is computed based on real-time features extracted from communications involving the agent and accumulated over a batch period. Agent fraud is detected based on a model and the detection result is used to audit the agent for service performance.

### BACKGROUND

Customer service provides an opportunity for companies to handle customer requests and address customer concerns. For example, a customer may contact customer service for questions on the charges, on service quality issues, new services, or adding or removing services. Customer service agents may be employed to take calls from customers in order to take care of the different types of customer needs. In addition to address issues raised by customers, service agents may also introduce new features of existing services or newly deployed services so that customers may be informed of the updates in services. In the meantime, agents who successful help customers to sign up for new services may be rewarded by the company.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary high level system diagram of a customer service platform for facilitating service agents to interact with customers for services related matters, in accordance with an embodiment of the present teaching;

FIG. 2A is a flowchart of an exemplary process for agent-based customer service via communications, in accordance with an embodiment of the present teaching;

FIG. 2B is a flowchart of an exemplary process for artificial intelligence (AI) based agent auditing on agent fraud, in accordance with an embodiment of the present teaching;

FIG. 3A depicts an exemplary high level system diagram of a real-time communication analyzer, in accordance with an embodiment of the present teaching;

FIG. 3B is a flowchart of an exemplary process of a real-time communication analyzer, in accordance with an embodiment of the present teaching;

FIG. 4A depicts an exemplary high level system diagram of an agent fraud detection unit, in accordance with an embodiment of the present teaching;

FIG. 4B illustrates exemplary types of features extracted from customer-agent communications for fraud detection, in accordance with an embodiment of the present teaching;

FIG. 4C is a flowchart of an exemplary process of an agent fraud detection unit, in accordance with an embodiment of the present teaching;

FIG. 5 depicts an exemplary architecture of an artificial neural network for feature-based agent fraud detection, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching is directed to a customer service platform with an AI-based auditing mechanism to detect agent fraud. Traditionally, when customers call customer service to ask questions and raise issues encountered in services, the agents goal is to help customers to resolve issues. In some situations, while talking to customers, agents may take the opportunity to, e.g., offer products/services that may address the issue encountered or introduce other available products/services that the customers currently do not subscribe to. Some customers may request to add services and agents may assist to implement what is requested by adding the services to the requesting customers account. Within the company, agents may be evaluated in terms of how they serve customers. An agent may be monetarily rewarded when the value of the additional services that the agent added enhances the financial return of the company. Such rewards to agents may grow proportionally with the amount of increased business.

In some situations, an agent may add new services to customers when there is no consent or authorization from the customers. In some industries, such as in the phone service industry or the like, such activities may be termed as “cramming,” defining a fraudulent practice of adding unauthorized charges or other paid services to a customer account. Cramming activities may damage customer relationships and negatively impact a company's business if the issue associated with unauthorized services does not surface until the impacted customer (who receives the unauthorized services with relevant charges) realizes that there are charges on services that they did not order or authorize.

The customer service platform according to the present teaching incorporates an AI-based auditing mechanism that processes transcripts of communications in real-time to extract relevant features for detecting agent fraud (or cramming activities). According to a batch schedule, real-time features may be consolidated to generate batch features based on which model-based fraud detection is performed. Auditing may be conducted based on fraud detection results. The batch schedule may be configured according to application needs so that agent fraud may be identified in a timeframe to prevent negative consequences to customers. In addition, such fraud detection results may be u to support performance evaluation of agents' service to customers.

Based on a transcript of a communication content between a customer and an agent, various real-time features associated with fraudulent cramming activities may be extracted from the transcript and then stored for further processing. In some embodiments, the real-time features may be detected on-the-fly. In some embodiments, the real-time features may also be detected offline to represent what went on in real-time during the communication. Such real-time features may be extracted based on different types of information identified from the communication, including a transaction associated with, e.g., a detected update to the customer's services, entities associated therewith (e.g., names of the updated service(s)), or any evidential characteristics or lack thereof in the communication that may support the transaction, such as inquiries from the customer about the updated service, intent of the customer with regard to the updated service, and/or a response of the customer expressed during the communication on the updated service. Preliminary agent fraud candidate may be identified by, e.g., raising a flag for cramming activities if the features represent a sufficient likelihood of agent fraud. The real-time features obtained from communications may be archived for batch agent fraud detection.

Each agent may be evaluated for cramming activities and agent fraud according to a batch schedule, which may be defined as a period of, e.g., each hour, several hours, each day, each week, etc. For example, at the end of the defined batch period, each agent may be evaluated based on, e.g., real-time features extracted from communications between the agent and customers occurred in the batch timeframe. The real-time features accumulated over a batch period with respect to each agent may be processed to generate a batch feature vector for the agent, which may then be used for evaluation. In some embodiments, exemplary features of a batch feature vector may include an aggregated fraud flag determined based on fraud flags raised in processing real-time communications, transactions carried out during the evaluation period, session intent which may estimate an intent of a customer in the session, e.g., on whether there is an intent to sign up an added new service. Features related to transactions may include a number of transactions (e.g., signing up services) occurred in the batch period, types of such transactions, and financial impact of such transactions.

A batch feature vector associated with an agent with respect to a batch period may be archived for agent's evaluation and used as an input to a model-based agent fraud detection classifier that may produce an output indicating, e.g., a likelihood as to whether agent fraud has been committed by the agent during the given batch period. The model-based classifier may be pretrained, via deep learning, based on training data. In some embodiments, in addition to a classification decision, additional statistics may also be computed based on batch features and/or the detection result to characterize the performance of the agent. For instance, based on the real-time features accumulated over the evaluation period for an agent, the frequency of detected cramming activities, the services involved in such cramming activities, and the accumulated financial impact of such unauthorized services may be determined and archived.

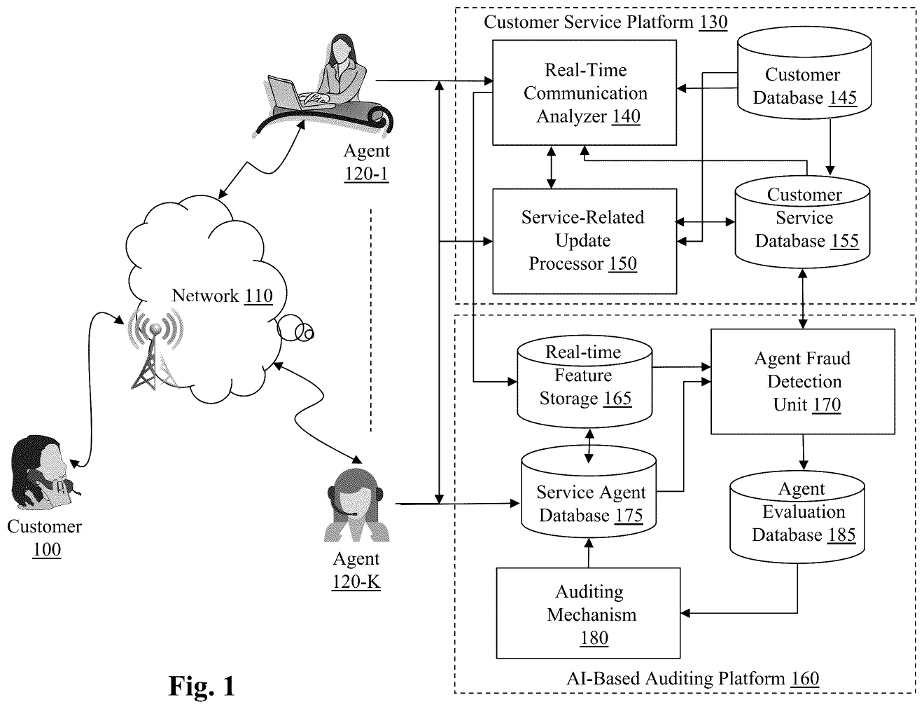

Based on the performance evaluation data for customer service agents, internal audit may be performed in a qualitative and quantitative manner. Appropriate corrective actions may be adopted to cease unauthorized services to customers due to agent fraud. As such, the AI-based auditing platform according to the present teaching enables automated evidence gathering on-the-fly to facilitate evidence-supported detection, self-correction to consequences of agent fraud, and prevention of damages to customer relationships due to cramming activities. Details of the customer service platform with AI-based auditing mechanism according to the present teaching are provided below with reference to FIGS. 1-5.

FIG. 1 depicts an exemplary high level system diagram of a customer service platform 130 for facilitating service agents 120 to interact with customers 100 for service related matters, in accordance with an embodiment of the present teaching. In this illustrated embodiment, the customer service platform 130 includes a frontend portion and a backend portion. The frontend portion facilitates a service agent (any of agents 120-1, . . . , 120-K) to communicate with a customer 100 via a network 110, handle customer's question/requests related to services, and computes real-time features from such communications. The backend portion may facilitate internal auditing functions with AI-based agent fraud detection and performance related statistics determination based on real time features computed by the frontend portion. The internal auditing enables performance related feedbacks to the service agents to enhance customer services.

The frontend portion may comprise a real-time communication analyzer 140 and a service-related update processor 150. Via communications with customers, agents 120 interface with the real-time communication analyzer 140 and the service-related updated processor 150 to provide what a customer needs. For example, a customer may make an inquiry about an existing service. An agent may interface with the service-related update processor 150 to, e.g., check the services the customer subscribed, and the terms associated with a service inquired by the customer (as specified in, e.g., a customer database 145 and a customer service database 155) to search for answers to respond to the customer. If a customer is requesting a new service, an agent may add the requested new service to the customer service database 155 via the service-related update processor 150. Similarly, if a customer desires to remove a service or change terms of an existing service, the agent may also interface with the service-related updated processor 150 to amend the services described in the customer service database 155.

While the agent interfaces with the frontend portion of the customer service platform 130 to address the questions/requests from a customer, the real-time communication analyzer 140 analyzes the transcript of the ongoing communication between the agent and the customer to extract different real-time features and stored such real-time features in a real-time feature storage 165 in the backend portion. Real-time features may be defined and computed to enable agent performance evaluation in the backend to support enhanced customer services. For instance, to detect cramming activities for minimizing agent fraud, features that are indicative of cramming activities may be extracted from the communication content. For example, transaction(s) carried out by an agent in connection with the communication may be detected and the customer's intent and responses expressed during the communication with respect to the service associated with the transaction may be defined and identified as relevant to the transaction.

The backend portion includes an agent fraud detection unit 170 and an auditing mechanism 180. The agent fraud detection unit 170 is provided for detecting agent fraud based on the real-time features from the frontend portion. In some embodiments, the agent fraud detection is carried out in a batch mode defined based on application needs. For example, to prevent services that are fraudulently signed up without customers' authorization, the batch operation may be configured to be performed each month before the billing cycle so that charges associated with the unauthorized services may be removed from customers' accounts. The detection may be performed with respect to each agent so that detected cramming activities from the agent corresponding to the agent fraud may be identified and then stored under the agent in an agent evaluation database 185.

Different types of information that may be used to assist agent evaluation may be stored. For example, a fraud classification result with, e.g., a classification confidence score, on whether cramming activities exist may be stored. Batch features used to reach the classification may also be stored as evidence supporting the classification result, including, e.g., aggregated fraud flags in the batch period, customers' intent detected from different communication sessions, and possibly customers' response to an offer of the added unauthorized services. Such evaluation information for each agent stored in the agent evaluation database 185 may subsequently be used for agent performance evaluation. Such evaluation may include both computer-aided automated evaluation as well as internal agent evaluation performed by management of a company.

The auditing mechanism 180 may be provided to perform computer-aided automated evaluation of agents' performance in customer services based on information stored in the agent evaluation database 185. For example, the auditing mechanism 180 may pull evaluation information related to each agent and then may assess accordingly the agent's performance. The assessment result may then be recorded in a service agent database 175 under each corresponding agent as a part of the agent record. For example, each fraud flag in the evaluation period may be recorded with dates and statistics associated therewith, including the frequency of cramming activities in each evaluation period, whether there is negative impact on company's financial status (e.g., company had to cancel the charges due to unauthorized nature even though services has been provided to impacted customers), the total financial impact to agent due to authorized services (e.g., incentive to the agent for the signed-up services prior to detecting the unauthorized nature), etc. Such information recorded under each agent may be accessed by the agent as part of communication between the agent and the company.

As discussed herein, the communication between agents and customers may be via the network 110. In some embodiments, the communication between agents and the customer service platform 130 may also be through the network 110. The network 110 as illustrated in FIG. 1 may be a local area network (LAN), a wide area network (WAN), a public network, a private network, a proprietary network, a Public Telephone Switched Network (PSTN), the Internet, a wireless network, a virtual network, or any combination thereof. Such a network or any portions thereof may be a 4G network, a 5G network, or a combination thereof. The network 110 may also include various network access points, e.g., wired, or wireless access points such as base stations or Internet exchange points, through which a particular customer may connect to the network in order to provide and/or transmit information to a specific destination. The information communicated between customer 100 and the customer service platform 130 (possible also between the agents 120 and the customer service platform 130) via network 110 may be delivered as bitstreams which may be encoded in accordance with certain industrial standards, such as MPEG4 or H.26x, and the network may be configured to support the transport of such encoded data streams.

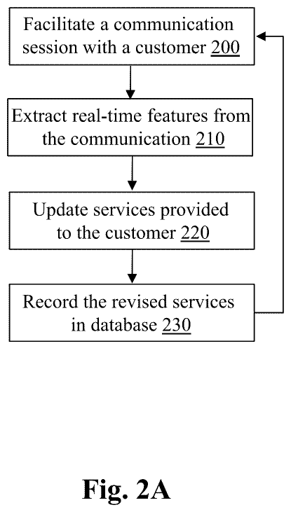

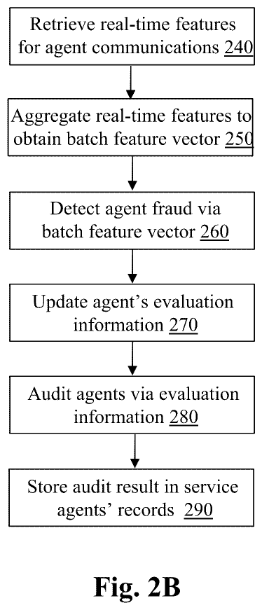

FIG. 2A is a flowchart of an exemplary process for agent-based customer service via communications, in accordance with an embodiment of the present teaching. At 200, the customer service platform 130 facilitates an agent to conduct a communication session with a customer. The communication is used to extract, at 210, various real-time features and such extracted real-time features are stored in the real-time feature storage 165. If the customer requests certain changes to the services, the service-related update processor 150 revises, at 220, services recorded in the customer service database 155. In some situations, the customer may request a change in a service term (e.g., change from 1,500 minute free/month program to 2,000 minute free/month program). In some situations, the customer may request to remove a service program such as parental control. In some situations, the customer may request to add a program, e.g., a video content service). The changes made to the existing service plan of a customer may then be recorded, at 230, in the customer service database 155. Such recorded changes to customer's service plan may subsequently be used by the agent fraud detection unit 170 to compare the changes made to the communication content and features thereof for detecting cramming activities.

FIG. 2B is a flowchart of an exemplary process of the AI-based auditing platform in the backend of the customer service platform 130, in accordance with an embodiment of the present teaching. In a batch operation, the agent fraud detection unit 170 may first retrieve, at 240, real-time features associated with an agent from the real-time feature storage 165. The retrieved real-time features may then be aggregated, at 250, to generate a batch feature vector for the agent characterizing the service communications conducted by the agent during a batch period. Some of the batch features may be obtained by comparing with information stored in the customer service database 155. For instance, if real-time features include information about any transactions/entities (e.g., service name) discussed in a communication between an agent and a customer. If there is no discussion about a particular service in communication with a customer but there is an added service to the customer account in the same period, the added service may be unauthorized.

Based on the batch feature vector computed for an agent with respect to a batch period, agent fraud detection is performed at 260 and the detection result as well as optionally relevant features may be used to update, at 270, the agent evaluation information stored in the agent evaluation database 185. The updated agent's evaluation information in the agent evaluation database 185 may be used by the auditing mechanism to audit, at 280, different agents and the auditing results may then be stored, at 290, as agents' records in the service agent database 175.

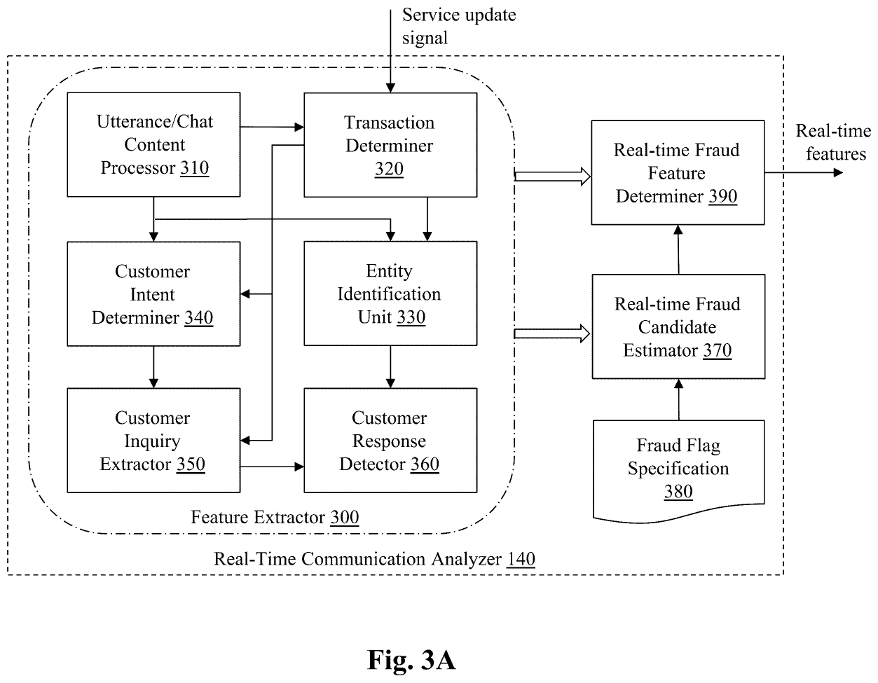

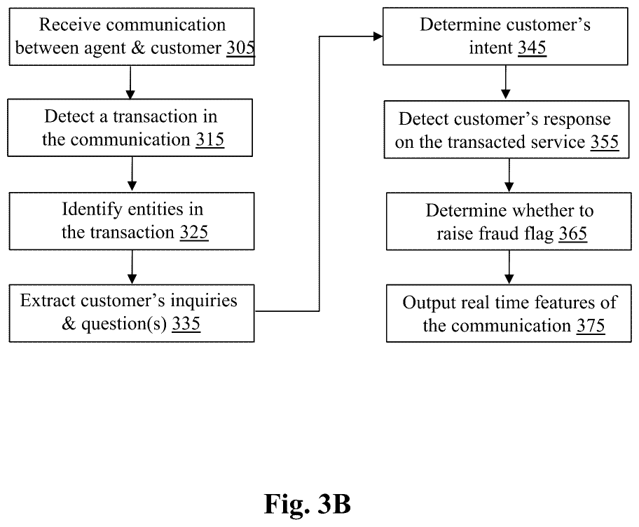

FIG. 3A depicts an exemplary high level system diagram of the real-time communication analyzer 140, in accordance with an embodiment of the present teaching. As discussed herein, real-time features may be extracted from a transcript of a communication between an agent and a customer, wherein the communication may be conducted in text or in voice, which may be converted into text via transcription via automated speech recognition. In some embodiments, exemplary types of real-time features may include one or more of transaction(s) (e.g., adding a new service) that may be involved in the communication, entity (e.g., name of the added service), an inquiry from the customer regarding the added service, an intent of the customer that may be exhibited during the communication (e.g., no indication of desire to sign up the added service), or a response from the customer which may be with respect to a, e.g., an introduction or a suggestion of the added service. Such real-time features may be relevant to the detection of cramming activities and may be extracted from the communications either on-the-fly or offline.

To facilitate the detection of real-time features, the real-time communication analyzer 140 comprises a feature extractor 300, a real-time fraud candidate estimator 370, and a real-time fraud feature determiner 390. The feature extractor 300 may be provided to extract exemplary features from a communication involving an agent and a customer, as discussed herein. The extracted features from the communication may then be used by the real-time fraud candidate estimator 370 to determine whether the extracted features characterize a cramming activity so that a flag may be raised to indicate that the agent in the communication may have committed an agent fraud. Based on the features extracted by the feature extractor 300 and the agent fraud flag with a value set by the real-time fraud candidate estimator 370, the real-time fraud feature determiner 390 may be provided to generate a set of real-time features (including the features extracted from the communication and the agent fraud flag) to represent the communication between the agent and the customer.

Depending on an application, different features may be extracted from a communication. In the embodiment illustrated in FIG. 3A, the feature extractor 300 may include an utterance/chat content processor 310, a transaction determiner 320, an entity identification unit 330, a customer intent determiner 340, a customer inquiry extractor 350, and a customer response detector 360. The utterance/chat content processor 310 may be provided to take a communication between an agent and a customer as input (either a text or an acoustic signal corresponding to voice communication) and produce a preprocessed transcript for further feature extraction. The transaction determiner 320 may be provided to identify any transaction corresponding to an update to the customer's services. In some embodiments, a transaction may include adding a new service, removing an existing service, or updating service terms of an existing service. In some embodiments, a transaction may be detected from the communication (e.g., the transaction was discussed during the communication). In some embodiments, a transaction may be recognized based on a service update signal received from the customer service database 155 when the customer's services are updated. For example, when a service description is modified in the customer service database 155, a corresponding flag may be raised based on the nature of the transaction (add/remove/update). In some embodiments, the service update signal may also be received from the service-related update processor 150 when it updates a service associated with the customer based on the interactions with the agent.

Whenever a transaction (service update) is detected, the feature extractor 300 may proceed to detect various features related to any evidentiary support for the transaction in the communication between the agent and the customer. The entity identification unit 330 may be provided for identifying entities mentioned in the communication and particularly whether any of the entities identified from the communication is the same as the service name corresponding to the transaction. For example, entity names may include, e.g., “international plan” or “Hulu video service.” The customer intent determiner 340 may be provided for detecting features about intent(s) of the customer from the communication, e.g., especially regarding the service updated via the transaction. The customer inquiry extractor 350 may be provided to identifying features from a part of the communication corresponding to an inquiry from the customer about the updated service. For example, it may be detected as to whether the customer has asked questions about the updated service such as the price/terms of adding the updated service. The customer response detector 360 may be provided to extract features that are indicative of any responses from the customer (e.g., agreement or disagreement) related to the updated service.

As discussed herein, such features may then be provided to the real-time fraud candidate estimator 370 and the real-time fraud feature determiner 390. The real-time fraud candidate estimator 370 may be configured to determine, based on, e.g., fraud flag specification 380, whether the detected features (entity, inquiry, intent, and response) as compared with the updated service involved in the transaction may indicate that the agent may have engaged in (a candidate) cramming activities. The fraud flag specification 380 may specify conditions to be met by the detected features to qualify as a candidate for agent fraud. If detected features from the communication involving an agent meet the cramming conditions specified in 380, the real-time fraud candidate estimator 370 may set an appropriate value of a cramming candidate flag in connection with the agent and send the flag to the real-time feature determiner 390, which may then combine the features detected by the feature detector 300 and the cramming candidate flag to generate the real-time features.

FIG. 3B is a flowchart of an exemplary process of the real-time communication analyzer 140, in accordance with an embodiment of the present teaching. The utterance/chat content processor 310 may receive, at 305, a communication between an agent and a customer and processes the communication accordingly for feature extraction. If a transaction is detected, at 315, in connection with a service updated for the customer by the agent, the entity identification unit 330 may identify, at 325, an entity corresponding to the updated service from the communication. The customer inquiry extractor 350 may proceed to extract, at 335, whether the customer has inquired about the updated service during the communication. The customer intent determiner 340 may be activated to determine at 345, the intent of the customer with respect to the updated service. The customer response detector 360 may also detect, at 355, whether there is a response from the customer on the service that is updated via the transaction. Based on the extracted features, the real-time fraud candidate estimator 370 may then determine, at 365, how to set the value of a cramming candidate flag for the agent. Upon receiving detected features (from the feature extractor 300) and the cramming candidate flag (from the real-time fraud candidate estimator 370), the real-time fraud feature determiner 390 then output, at 375, the real-time features so extracted.

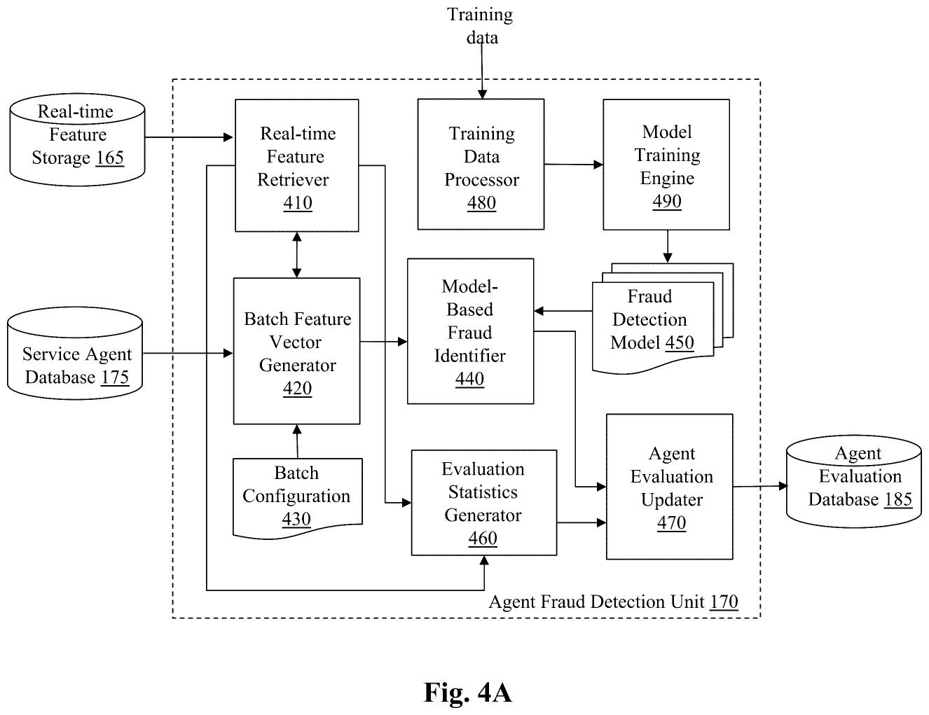

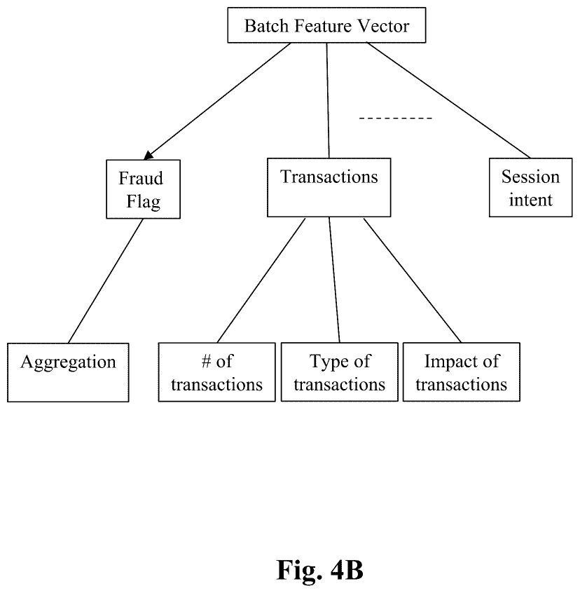

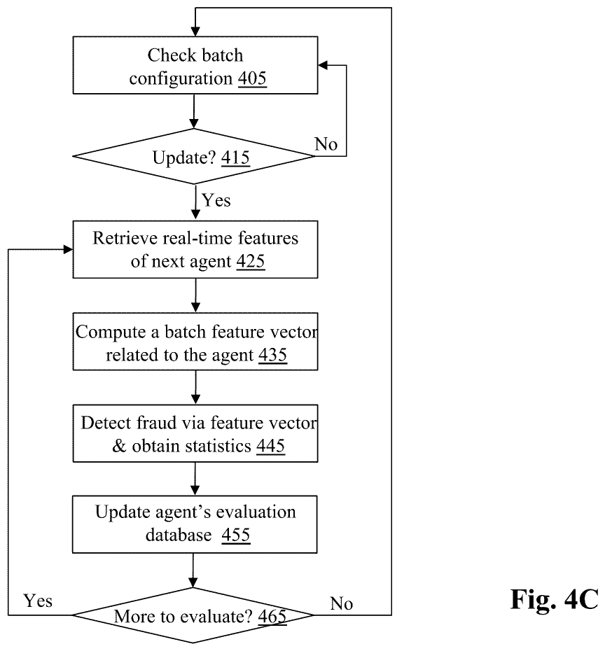

As discussed herein, the real-time features extracted in the frontend from the communications are archived in the real-time feature storage 165 so that the agent fraud detection unit 170 in the backend portion of the customer service platform 130 may carry out batch-based agent fraud detection (see FIG. 1) based on batch feature vectors for agents computed based on real-time features accumulated for agents during a batch period. FIG. 4A depicts an exemplary high level system diagram of the agent fraud detection unit 170, in accordance with an embodiment of the present teaching. The agent fraud detection unit 170 may detect fraud with respect to each agent registered in the service agent database 175 in each batch period. For example, for each agent, the agent fraud detection unit 170 may identify customers that the agent served during the period and the services that were updated during the period for these customers based on, e.g., the real-time features associated with the agent as stored in storage 165. The fraud detection result for each agent may then be stored in the agent evaluation database 185 and used by the auditing mechanism 180 for agent performance auditing.

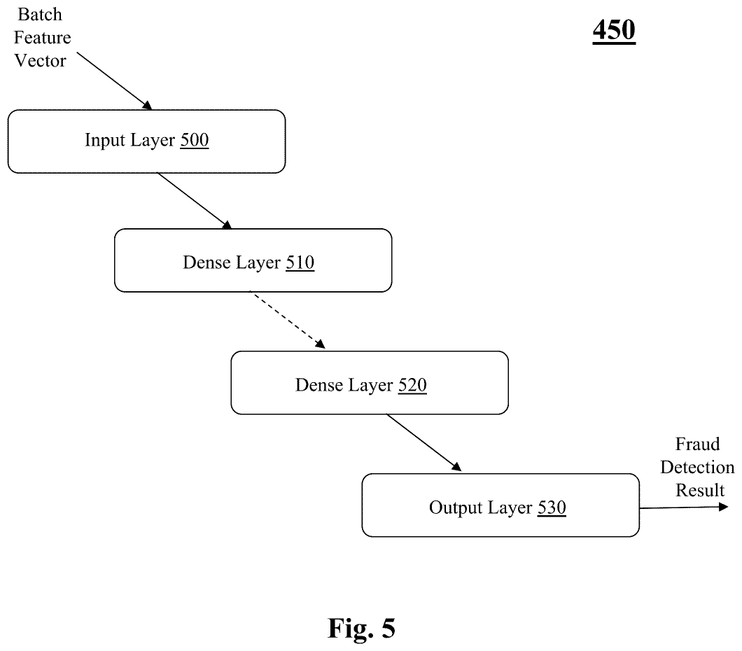

In this illustrated embodiment in FIG. 4A, the agent fraud detection unit 170 comprises a batch feature vector generator 420, a real-time feature retriever 410, a model-based fraud identifier 440, an evaluation statistics determiner 460, an agent evaluation updater 470. The agent fraud detection unit 170 may further include a mechanism for training a fraud detection model 450 to be used for agent fraud detection. In some embodiments, the mechanism may comprise a training data processor 480 for processing collected training data and a model training engine 490 for using the processed training data to train the fraud detection model 450. In some embodiments, an artificial neural network (ANN) may be employed to implement the fraud detection model 450. This is illustrated in FIG. 5, where the fraud detection model 450 includes multiple layers, e.g., an input layer 500, several dense layers 510 to 520, and an output layer 530. The input layer 500 may take a batch feature vector associated with an agent and the output layer 530 may output a fraud detection result. Each layer may have a plurality of nodes and nodes between different layers may be connected, either in full or in partial, with weights thereon. Each node in the ANN may perform some designated functions defined based on some variable. The weights and variables included in the ANN may constitute learnable parameters whose values may be adjusted during training to minimize some defined loss. The trained fraud detection model 450 may then be used in operation to detect agent fraud with respect to each agent based on a batch feature vector computed based on real-time features associated with the agent.

In this illustrated embodiment, the batch feature vector generator 420 is provided to operate in a batch mode, controlled by a batch configuration 430, to generate, with respect to each agent, a batch feature vector based on real-time features retrieved by the real-time feature retriever 410 from the real-time feature storage 165 for the agent. The batch feature vector of each agent may include different features accumulated from real-time features retrieved from storage 165. FIG. 4B illustrates exemplary types of batch features for fraud detection, in accordance with an embodiment of the present teaching. For example, a batch fraud flag may be obtained by aggregating the fraud flags from real-time features to represent the severity of fraud during the batch period. It may also include session related intent, indicative of a level of intent of the agent to commit fraud. This may be obtained based on accumulated intent detected during the batch period. Other types of batch features may also include different types of information associated with transactions involving updating customers' service plans. For example, transaction related features may include the number of transactions made during the batch period, respective types of transactions, as well as the impact of these transactions. They together may characterize the detected fraud in terms of frequency and the harm to both customers involved as well as to the company.

Once a batch feature vector for each agent is computed by the batch feature vector generator 420, it may be provided to the model-based fraud identifier 440, which may rely on the fraud detection model 450 to recognize (e.g., by classification) whether the agent committed agent fraud according to the batch feature vector. The classification result may be derived with a probability which may indicate the confidence in the detection result. In some embodiments, the classification result may include multiple outcomes (e.g., no agent fraud and agent fraud) each with a probability. In addition, the evaluation statistics determiner 460 may optionally determine certain relevant statistics (e.g., the percent of agent fraud during the batch period, the total financial damage to the company, the total harm to the customers, etc.) that may be useful to assessment the degree of agent fraud. In some embodiments, such statistics may be computed from the real-time features extracted from different communications with different customers during the batch period. The classification result and the statistics characterizing the agent detection result may be both provided to the agent evaluation updater 470, which may then use the detection result associated with the agent to update the agent's evaluation record in the agent evaluation database 185.

FIG. 4C is a flowchart of an exemplary process of the agent fraud detection unit 170, in accordance with an embodiment of the present teaching. As discussed herein, in some embodiments, the backend agent fraud detection may be performed in a batch mode based on real-time features captured from communications between agents and customers. Such real-time features may be saved in storage 165 with respect to, e.g., each agent. In a batch mode, the real-time features associated with each agent (accumulated in the current batch period) may be relied on for agent fraud detection. In operation, the batch feature vector generator 420 may check, at 405, whether a condition specified in the batch configuration 430 is satisfied until, determined at 415, the condition of the batch configuration 430 is met (e.g., every day at 12:00 am). When that happens, the real-time feature retriever 410 may be invoked to retrieve, at 425, real-time features with respect to each of the agents from storage 165.

Based on the real-time features retrieved for an agent, the batch feature vector generator 420 computes, at 435, a batch feature vector for the agent, which is then used by the model-based fraud identifier 440 to detect, at 445, whether agent fraud exists during the current batch period. The evaluation statistics determiner 460 may then obtain relevant statistics (e.g., as illustrated in FIG. 4B) associated with the agent. The agent evaluation updater 470 may use the agent fraud detection result as well as the relevant statistics to update, at 455, the performance evaluation record associated with the agent in the agent evaluation database 185. The process may then repeat for each agent, determined at 465, until the agent fraud detection is completed for all agents. The process then returns to 405 to wait for the next batch period. Each batch operation generates updated evaluation information for each agent in database 185 and such updated evaluation information may then be utilized by the auditing mechanism 180 to audit any of the agents, as shown in FIG. 1.

In some embodiments, the auditing mechanism 180 may automatically generate audit result for each agent being audited and save the audit result in, e.g., the personal record of the agent in the service agent database 175. In some embodiments, the audit result for each agent may be linked to real-time features detected from communications of the agent with customers during the batch period and saved in the real-time feature storage 165 to provide support for the audit result. Such agent records may be accessible to both the agents and the management of the company. The AI-based auditing platform 160 provides an AI-based automated means for monitoring cramming activities and minimizing negative consequences of agent fraud. This facilitates improvement to customer service quality.

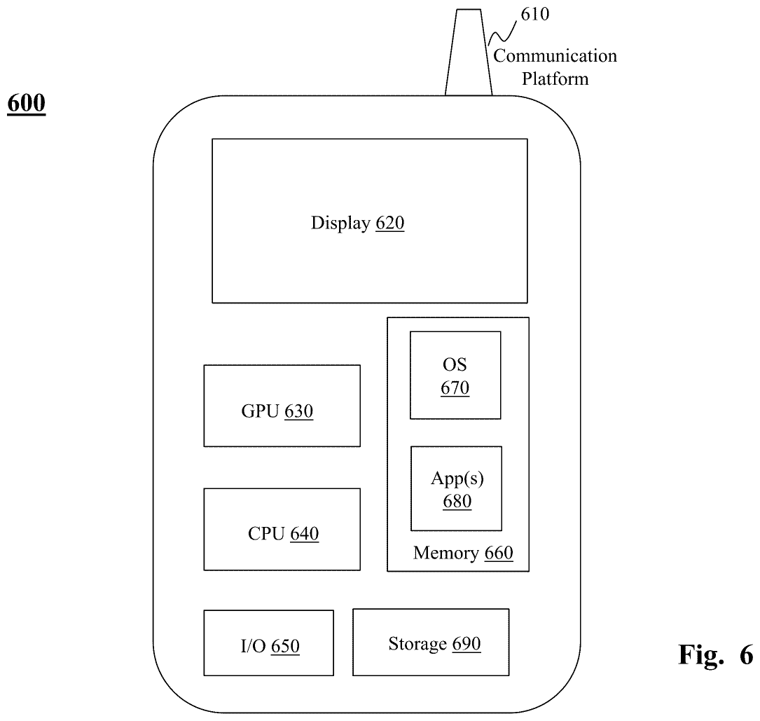

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

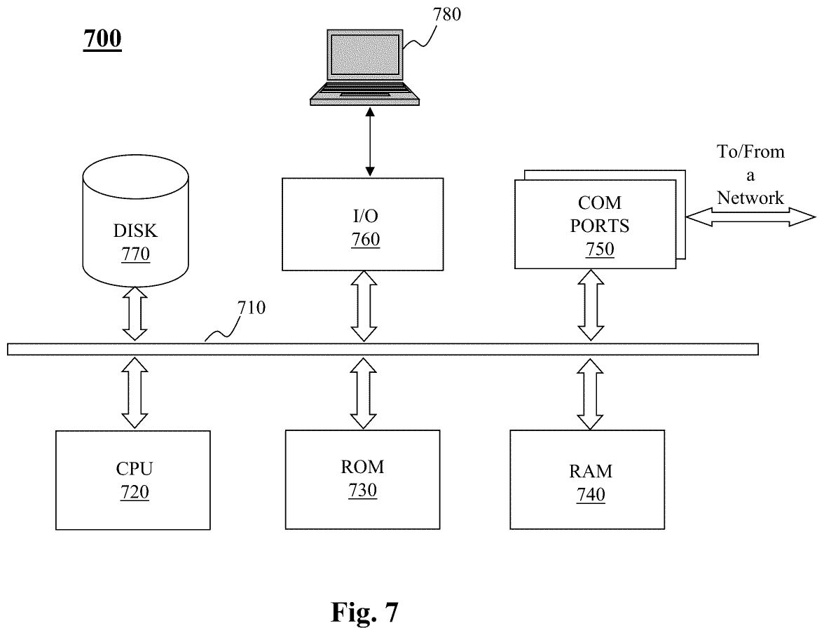

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
extracting real-time features from a communication between a customer and an agent;
computing a batch feature vector for the agent with respect to a batch period based on real-time features extracted from communications involving the agent and accumulated during the batch period;
detecting, based on a fraud detection model, agent fraud of the agent occurred during the batch period based on the batch feature vector to generate an agent fraud detection result;
updating evaluation information associated with the agent based on the agent fraud detection result to generate updated evaluation information of the agent; and
auditing service performance of the agent based on the updated evaluation information.

2. The method of claim 1, wherein the extracting the real-time features comprises:
analyzing the communication;
detecting one or more transactions performed by the agent and features associated with each of the one or more transactions;
setting a fraud flag, with respect to each of the one or more transactions, based on the features associated therewith; and
outputting the features associated with each of the one or more transactions and the corresponding fraud flags as the real-time features of the communication.

3. The method of claim 2, wherein each of the transactions involves one of:
adding a service to the customer;
removing an existing service currently provided to the customer; and
modifying a term of an existing service currently provided to the customer.

4. The method of claim 2, wherein the features associated with each of the transactions include at least one of:
an entity corresponding to a service involved in the transaction;
an inquiry of the customer regarding the service;
a response of the customer regarding the service; and
an intent of the customer detected from the communication.

5. The method of claim 1, wherein the computing the batch feature vector comprises:
retrieving the real-time features relating to the communications involving the agent occurred in the batch period;
aggregating the retrieved real-time features;
obtaining batch features based on the aggregated real-time features; and
creating the batch feature vector based on the batch features.

6. The method of claim 5, wherein the batch features include at least one of:
at least one aggregated fraud flag;
an intent detected for each of communication sessions included in the batch period; and
information related to transactions detected in the communication sessions, comprising at least one of:
a type of each of the transactions,
an impact of each of the transactions, and
a number of the transactions.

7. The method of claim 1, wherein the detecting the agent fraud comprises:
providing the batch feature vector as an input to a fraud detection model; and
outputting, by the fraud detection model, the agent fraud detection result, wherein
the fraud detection model is pretrained via machine learning based on training data.

8. A machine readable and non-transitory medium having information recorded thereon, wherein the information, when read by the machine, causes the machine to perform the following steps:
extracting real-time features from a communication between a customer and an agent;
computing a batch feature vector for the agent with respect to a batch period based on real-time features extracted from communications involving the agent and accumulated during the batch period;
detecting, based on a fraud detection model, agent fraud of the agent occurred during the batch period based on the batch feature vector to generate an agent fraud detection result;
updating evaluation information associated with the agent based on the agent fraud detection result to generate updated evaluation information of the agent; and
auditing service performance of the agent based on the updated evaluation information.

9. The medium of claim 8, wherein the extracting the real-time features comprises:
analyzing the communication;
detecting one or more transactions performed by the agent and features associated with each of the one or more transactions;
setting a fraud flag, with respect to each of the one or more transactions, based on the features associated therewith; and
outputting the features associated with each of the one or more transactions and the corresponding fraud flags as the real-time features of the communication.

10. The medium of claim 9, wherein each of the transactions involves one of:
adding a service to the customer;
removing an existing service currently provided to the customer; and
modifying a term of an existing service currently provided to the customer.

11. The medium of claim 9, wherein the features associated with each of the transactions include at least one of:
an entity corresponding to a service involved in the transaction;
an inquiry of the customer regarding the service;
a response of the customer regarding the service; and
an intent of the customer detected from the communication.

12. The medium of claim 8, wherein the computing the batch feature vector comprises:
retrieving the real-time features relating to the communications involving the agent occurred in the batch period;
aggregating the retrieved real-time features;
obtaining batch features based on the aggregated real-time features; and
creating the batch feature vector based on the batch features.

13. The medium of claim 12, wherein the batch features include at least one of:
at least one aggregated fraud flag;
an intent detected for each of communication sessions included in the batch period; and
information related to transactions detected in the communication sessions, comprising at least one of:
a type of each of the transactions,
an impact of each of the transactions, and
a number of the transactions.

14. The medium of claim 8, wherein the detecting the agent fraud comprises:
providing the batch feature vector as an input to a fraud detection model; and
outputting, by the fraud detection model, the agent fraud detection result, wherein
the fraud detection model is pretrained via machine learning based on training data.

15. A system, comprising:
a customer service platform implemented by a processor and configured for extracting real-time features from a communication between a customer and an agent; and
an artificial intelligence (AI)-based auditing platform implemented by a processor and configured for
computing a batch feature vector for the agent with respect to a batch period based on real-time features of communications involving the agent and accumulated during the batch period,
detecting, based on a fraud detection model, agent fraud of the agent occurred during the batch period based on the batch feature vector to generate an agent fraud detection result,
updating evaluation information associated with the agent based on the agent fraud detection result to generate updated evaluation information of the agent, and auditing service performance of the agent based on the updated evaluation information.

16. The system of claim 15, wherein the customer service platform includes a real-time communication analyzer implemented by a processor and configured for extracting the real-time features by:
analyzing the communication;
detecting one or more transactions performed by the agent and features associated with each of the one or more transactions;
setting a fraud flag, with respect to each of the one or more transactions, based on the features associated therewith; and
outputting the features associated with each of the one or more transactions and the corresponding fraud flags as the real-time features of the communication.

17. The system of claim 16, wherein
each of the transactions involves one of:
adding a service to the customer,
removing an existing service currently provided to the customer, and
modifying a term of an existing service currently provided to the customer; and
the features associated with each of the transactions include at least one of:
an entity corresponding to a service involved in the transaction,
an inquiry of the customer regarding the service,
a response of the customer regarding the service, and
an intent of the customer detected from the communication.

18. The system of claim 15, wherein the AI-based auditing platform includes an agent fraud detection unit implemented by a processor and configured for computing the batch feature vector by:
retrieving the real-time features relating to the communications involving the agent occurred in the batch period;
aggregating the retrieved real-time features;
obtaining batch features based on the aggregated real-time features; and
creating the batch feature vector based on the batch features.

19. The system of claim 18, wherein the batch features include at least one of:
at least one aggregated fraud flag;
an intent detected for each of communication sessions included in the batch period; and
information related to transactions detected in the communication sessions, comprising at least one of:
a type of each of the transactions,
an impact of each of the transactions, and
a number of the transactions.

20. The system of claim 15, wherein the AI-based auditing platform further includes an agent fraud detection unit implemented by a processor and configured for detecting the agent fraud by:
providing the batch feature vector as an input to a fraud detection model; and
outputting, by the fraud detection model, the agent fraud detection result, wherein
the fraud detection model is pretrained via machine learning based on training data.
